(19) United States
(12) Patent Application Publication
(10) Pub. No.: US 2020/0174917 A1
(43) Pub. Date: Jun. 4, 2020

(54) Rapid Automation First-pass Testing Framework

(71) Applicant: Bank of America Corporation, Charlotte, NC (US)

(72) Inventors: Akshay Patel, Cary, NC (US); Alexander Arkadyev, Thornhill, Ontario (CA); Ramesh Sharma, Brampton, Ontario (CA); Richard Liang, Oakville, Ontario (CA); Shiridish Billa Kota, Hyderabad (IN)

(21) Appl. No.: 16/207,618

(22) Filed: Dec. 3, 2018

(51) Int. Cl. G06F 11/36; G06F 8/41

(52) U.S. Cl. CPC G06F 11/3692; G06F 8/42; G06F 11/3696; G06F 11/3664

(57) ABSTRACT

Aspects described herein may relate to an application code testing computing device, which may be configured to run an application code testing plug-in and a framework core. The application code testing computing device may receive a set of codeless instructions (for example a Gherkin format) for testing one or more applications associated with one of a plurality of technology types, where each of the technology types is associated with a library component supported by the framework core. The application code testing computing device determines the associated technology type from the syntax of one or more steps contained in the set of instructions. Moreover, the application code testing computing device may detect a change of the technology type when executing test script from the syntax of currently processed steps.

### TECHNICAL FIELD

One or more aspects of the disclosure generally relate to computing devices, computing systems, and computer software. In particular, one or more aspects of the disclosure generally relate to computing devices, computing systems, and computer software that may be used as a tool for testing applications, such as a code testing tool.

### BACKGROUND

With wide adoption of agile development methodologies, behavior-driven development (BDD) and various systems and tools supporting it have become more and more popular. Such systems and tools provide a bridge between natural language constructs (for example, English-like sentences describing features, user stories, and the like) and automated tests. However, these systems and tools do not come out of the box with a built-in backend automation system, and integration with an external automation tool or framework is typically used. Known implementations of such integrations involve heavy coding, especially when it comes to supporting domain-specific languages (DSL). These solutions are less efficient (for example, less time efficient), require strong backend system development skills, and limit adoption of such solutions into agile development. Many of those implementations also do not scale up well, and suffer from lack of robustness and from poor maintainability.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

The proposed system and tool for testing applications eliminates certain types of coding, while automating behavior-driven development (BDD) scenarios. BDD is a development methodology based on communication between the business users, the developers, and the testers. To enable collaboration between teams, including product development teams, Domain Specific Language (DSL) and declarative styles of DSL features may be used. Solutions described herein enable quick implementation of BDD automation (resulting in time savings) and achieve high levels of scalability, robustness, maintainability, flexibility, and efficiency of a cumulative solution. The solution extends the possibilities of using automation in a current agile development iteration, allows further shift left in testing, and reaches maximal first pass automation. For example, scripting may begin from user interface specifications without using application code, automated scripts may be used for first pass testing, and automation scripts may be used for initial testing. It also allows development teams to reap the benefits of automation for their own testing, without having to spend time on writing the automation code first.

Aspects described herein may relate to an application code testing computing device, which may be configured to run an application code testing plug-in. The application code testing computing device may receive a set of instructions for testing one or more user interface pages of an application under test. The application code testing computing device may determine that the set of instructions is written in a first format, and the computing device may parse the set of instructions to determine an action to perform and to determine data to use for the action to perform in response to determining that the set of instructions is written in the first format. The first format may comprise an imperative scenario written in Gherkin format or a declarative scenario written in Gherkin format. Systems described herein may convert the determined action to perform to a second format to generate a converted action to perform and/or convert the determined data to use for the action to perform to the second format to generate converted data. The application code testing computing device may send, to an application framework, the converted action to perform and the converted data.

In some aspects, parsing the set of instructions to determine the action to perform may comprise determining, in the set of instructions, a location of a trigger indicating the action to perform. Based on the location of the trigger indicating the action to perform, it may be determined that text in the set of instructions following the trigger comprises a name of the action to perform. Additionally or alternatively, parsing the set of instructions to determine the data to use for the action to perform may comprise determining, in the set of instructions, a location of a trigger indicating the data to use for the action to perform. Based on the location of the trigger indicating the data to use for the action to perform, it may be determined that text in the set of instructions following the trigger comprises a name or a location of a data sheet storing the data to use for the action to perform.

With another aspect of the embodiments, a Rapid Automation First-pass Testing (RAFT) framework supports different applications spanning a plurality of technology types (for example, Web UI, Thick Client, Mobile, Web Services and Database). The RAFT framework may select the technology type based on syntax of a provided test artifact (for example, a codeless test script). Moreover, the technology type may change during the processing of the test artifact.

With another aspect of the embodiments, different applications for a same technology type may utilize the same step definitions. However, different step definitions may be needed when testing another application for a given technology type.

With another aspect of the embodiments, a RAFT framework supports a plurality of options for step definitions when processing steps of a provided test script. Options may include, but not limited to, codeless groups of steps, pre-defined codeless steps, and coded steps (for example, Java™ code). An application for one of the technology types may execute the processed steps via the RAFT framework in conjunction with a corresponding automation library.

With another aspect of the embodiments, a RAFT framework supports codeless automation in a number of ways. First, pre-defined Gherkin steps with data parameterization in external files instruct an application to perform one or more actions. Second, a repetitive combination of actions may be combined into a group action. Third, custom steps/step definitions may be added to generate reports for testing applications through a RAFT framework.

With another aspect of the embodiments, reports may be generated from testing applications of different technology types. A report may be characterized by one of different formats and may enable a user to drill down into testing details varying from a high level to the specifics of log data as well as screen shots. The report may be contained in a single file, where information is embedded in the file, circumventing the need for having a plurality of files. Consequently, the depth of analyzing a report can be determined after generating the report file.

### BRIEF DESCRIPTION OF THE DRAWINGS

The present disclosure is illustrated by way of example and not limited in the accompanying figures in which like reference numerals indicate similar elements and in which:

FIG. 1 illustrates an example system and framework comprising computing devices in accordance with one or more example embodiments.

FIG. 2 illustrates another example system and framework comprising computing devices in accordance with one or more example embodiments.

FIGS. 3A-B illustrates a component interactions flow for a Rapid Automation First-pass Testing framework according to one or more illustrative embodiments.

FIG. 4 illustrates an example of a suitable computing system environment for supporting the framework shown in FIG. 2 according to one or more illustrative embodiments.

FIG. 5 illustrates a feature file in accordance with one or more example embodiments.

FIG. 6 illustrates various options that may be used with step definitions when processing a codeless testing script in accordance with one or more example embodiments.

FIG. 7 shows a flowchart that may be executed by a computing device for processing a codeless test script in accordance with one or more example embodiments.

FIGS. 8-10 illustrate an example of a test report after executing a test script through a Rapid Automation First-pass Testing framework in accordance with one or more example embodiments.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

Embodiments may support a number of deficiencies with respect to traditional approaches. First, a Rapid Automation First-pass Testing (RAFT) framework supports extreme shift-left automation. Consequently, automation can start prior to coding the application. With traditional approaches, one typically must wait for application code to be deployed before starting automated testing.

Second, a RAFT framework may support a Gherkin syntax, with test case documentation being directly executable without manual coding or scripting. Consequently, automation scripts are auto-generated from test case documentation. With traditional approaches, a second artifice (for example, Java™ code) is often manually created by someone from a first artifact (for example, codeless script using a Gherkin syntax).

Third, a RAFT framework may support a plurality of technology types including, but not limited to, Web-UI, Thick client, Web services, mobile, and database/ETL (Extract, Load, and Transform) applications. Other technology types can be added if necessary. Consequently, a single integrated solution (framework) may provide all applications automation needs. Traditional approaches may require separate frameworks for different technology types.

Fourth, a RAFT framework may support a tight integration with continuous integration—continuous deployment (delivery) (CI-CD) tools and test execution harnesses.

With an aspect of the embodiments, cognitive computing and analytics may be applied to test cycle responsibilities.

With an aspect of the embodiments, a RAFT framework enables streamlining of application test cycles from machine learning to artificial intelligence (AI) driven use cases for capabilities such as test optimization, test failure analysis, defect management, and root cause analysis.

As a brief introduction, the proposed system and tool for testing applications eliminates certain types of coding, while automating behavior-driven development (BDD) scenarios. BDD is a development methodology based on communication between the business users, the developers, and the testers. To enable collaboration between teams, including product development teams, Domain Specific Language (DSL) and declarative styles of DSL features may be used. Solutions described herein enable quick implementation of BDD automation (resulting in time savings) and achieves high levels of scalability, robustness, maintainability, flexibility, and efficiency of a cumulative solution. The solution extends the possibilities of using automation in a current agile development iteration, allows further shift left in testing, and reaches maximal first pass automation. For example, scripting may begin from user interface specifications without using application code, automated scripts may be used for first pass testing, and automation scripts may be used for initial testing. It also allows development teams to reap the benefits of automation for their own testing, without having to spend time on writing the automation code first.

In some aspects, an automation framework may receive one or more instructions (for example, an instruction sheet, such as a spreadsheet information sheet) as input and extract from the instruction sheet specific information about the action to be performed by the framework and the data that may be used for the action. That is, the instruction sheet may define actions and input data for the functionalities of the application to be tested.

In additional or alternative aspects, a tool (for example, a code testing tool, such as a user acceptance testing tool) that supports BDD may be used, such as Cucumber or any other tool that supports BDD. The code testing tool may be used to perform regression testing on application code, such as a user interface (UI) application code. The UI application may comprise a web-based application. With some development tools, steps to be taken by the BDD automation framework may be written in, for example, natural text or language (a humanly readable plain text format). While the steps are written in a different format, the steps may indicate essentially the same information as other development tools, such as the action or actions to be performed and with what data to perform the action. In order to integrate a code testing tool with a certain framework, the information may be converted to a format acceptable by the framework.

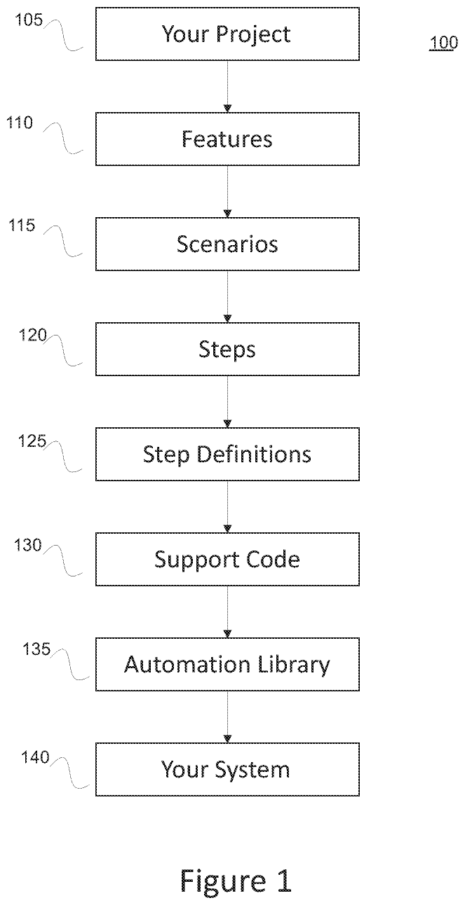

FIG. 1 illustrates an example system and framework for rapid automation first-pass testing comprising computing devices in which various aspects of the disclosure may be implemented. With one aspect of the embodiments, only one testing artifact needs to be generated. With traditional approaches, two testing artifacts are typically needed, where a first testing script is applied to test application manually. Subsequently, code (for example, written in the Java language) is written to parallel the first artifact in order to automate the testing of the application.

Framework 100 may comprise project 105, such as an application to be tested or other project. Framework 100 may comprise features 110. Features 110 may comprise a user story and/or test definition files. Framework 100 may comprise scenarios 115. Scenarios 115 may comprise acceptance criteria and/or tests for a given feature. Framework 100 may comprise steps 120. Steps 120 may comprise actions (for example, operations) to be performed to execute a particular scenario. The actions to be performed may be based on certain format or syntax (for example, a first format), such as Given/When/Then syntax as used in, for example, the Gherkin language.

Framework 100 may comprise step definitions 125. Step definitions 125 may comprise code, such as glue code, that maps a business-readable language of each step 120 into code to carry out the action being described by the step. Step definitions 125 may be short, such as a definition directing the execution flow to support code. However, the coding may also be done in step definitions 125 themselves. With one aspect of the embodiments, once step definitions 125 have been implemented, the implemented step definitions may be reused for subsequent test scripts. With traditional approaches, new code at the backend typically needs to be constructed when automating another test script.

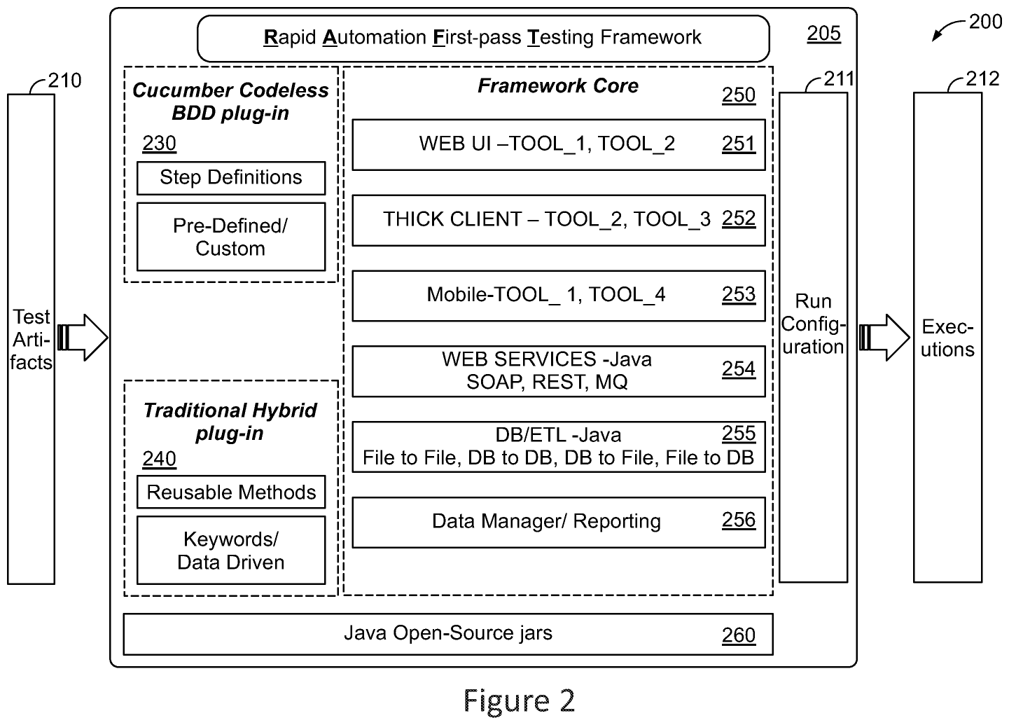

Framework 100 may comprise support code 130. Support code 130 may comprise the part of the code that knows how to carry out common tasks on the system. Most of the testing work may be done with support code 130. In some aspects, the role of support code 130 may be performed by a Rapid Automation First-pass Testing framework (for example, framework 205 as shown in FIG. 2). Framework 100 may comprise automation library 135. Automation library 135 may enable interaction with the system or application being tested (for example, system 140).

Because steps 120 are processed in an automated fashion via step definitions 125, a second artifact is circumvented. With traditional approaches, code (for example, in the Java language) is typically manually constructed from a first artifact.

The code testing tool described herein may be used by the framework 100 as an interface between business-facing components, such as the features 110, scenarios 115, and steps 120, and technology-facing components, such as the step definitions 125, support code 130, and automation library 135.

The code testing tool may comprise a plug-in module (for example, plug-in 230 and/or plug-in 240 as shown in FIG. 2) designed to achieve one or more of the goals described herein. Features and components of the code testing tool and/or the plug-in module will be described in further detail in the examples below.

Cucumber plug-in module 230 allows using Cucumber feature files as an input to RAFT framework 205. Plugin module 240 allows to support another, Excel based format of input, typical for Hybrid Keyword-Driven frameworks. The functionality implemented in plugin 240 may also be used to support reusable groups that will be described in further detail.

FIG. 2 illustrates another example system and framework comprising computing devices in which various aspects of the disclosure may be implemented. System 200 may comprise Rapid Automation First-pass Testing (RAFT) framework 205, which may comprise a framework core 250. With some embodiments, framework core 250 may be where the vast majority of automation code is located. The code may be used for codeless automation.

The framework core 250 may comprise standard actions, which may comprise one or more standard actions that may be taken by the system 200. For example, framework core 250 may support a Web UI technology with exemplary actions that include, but are not limited to, basic UI controls (for example, UIMap, such as UIMap.Fill, UIMap.Verify, UIMap.Act, and the like, or UITable) and also actions supporting various table-related tasks. Exemplary table-related tasks include, but are not limited to filtering and sorting various columns, searching for rows based on their content, verifying content in tables, rows, or cells, editing any table elements and acting on them, selecting rows, expanding rows, or deleting rows, among other actions.

Framework core 250 may comprise object repository (OR) support tools (not explicitly shown in FIG. 2) used to create and/or work with object repositories. Object repositories will be described in further detail below. The framework core 250 may comprise a reporting component (not explicitly shown in FIG. 2). Reporting may be used to generate one or more drill-down reports for analysis, and may support various types or formats of reports. The reporting component may allow report customization to the level of detail used for successful analysis of execution results.

Framework core 250 may support an automation library having a plurality of library components, where each component is associated with different technology types. Exemplary technology types include:
Web UI—relates to the way through which a user interacts with an application or a website
Thick Client—relates to full-features computers that include hard drives and other features
Mobile—relates to mobile apps
Web Services—relates to Web-based applications
Database/ETL—relates to data storage to/from databases including data warehouses

Web UI, Thick Client, Mobile, Web Services, and Database/ETL technologies correspond to library components 251-255, respectively, while Data Management and Reporting correspond to library component 256.

Library components 251-256 typically provide an interface to interact with various types of applications. For example WEB UI Libs (library component 251) may enable a user to interact with different types of browsers using different tools. For applications that have APIs exposed, interaction is typically done via API calls. For hybrid applications, that expose both UI and API (for example, Mainframe), libraries may allow switching from one technology to another seamlessly.

As shown in FIG. 2, more than one tool may be used for each technology (for example, TOOL_1 and TOOL_2 for the Web UI technology) and the same tool may be used for more than one technology (for example, TOOL_1 for the Web UI and the mobile technologies).

One or more applications may be supported within a particular technology type. As will be discussed in further detail, framework 205, determines the associated technology type from the syntax of testing artifact 210 (for example, codeless testing script). The associated library component enables framework 205 to interact with the system or application being tested (for example, system 140 as shown in FIG. 1) via run configuration 211 and execution 212.

A new technology type may be supported by framework 205 by adding a corresponding library component to framework core 250.

The framework 205 may comprise one or more components that may process data after execution is performed by the framework core 250. For example, the framework 205 may comprise a keyword driver that provides keywords for use by an instruction (for example, data) sheet or file (for example, in a spreadsheet or table format). The instruction sheet may be read, for example, row by row, to identify test cases listed in the instruction sheet. The steps of each test case may be processed. For each step, framework 205 may extract information about the action to be executed and the data to be used for the action. That is, these pieces of information may be passed to the framework core 250 and/or an application specific component for processing. The information may be sent to the framework core 250 and/or an application specific component in a format that the framework understands. For example, the action information may be formatted as UIMap.Fill or UITable.Filter, and the data may be formatted as <DataSheetName, RowNumber/RowLabel>.

The framework 205 may comprise a code testing tool 230, which may be a plug-in. As previously described, steps processed by the code testing tool 230 may be written in humanly readable plain text form. The data sent from the code testing tool 230 to the framework may be similar or essentially the same as the data received via the keyword driver, such as what actions are to be performed and with what data. In order to integrate the code testing tool 230 with framework 205, the code testing tool 230 may convert the information (for example, action to be performed and/or with what data) to a format usable by the framework 205. For example, the code testing tool may convert an action to perform from a first format (for example, Gherkin format) to a second format to generate a converted action to perform and convert the data to use for the action to perform to the second format to generate converted data. The code testing tool may send, to an application framework, the converted action to perform and the converted data, as will be described in further detail below.

The code testing tool 230 may determine (for example, monitor or keep track of) the context of each operation, such as which application is being tested, which page the tool 230 is on, and the like. Determining the context information might not be repeated in each step, and may be performed (for example, by mentioning or otherwise including the command) at the beginning of a feature or a scenario.

The code testing tool 230 (and components therein) may use a set of instructions (for example, one or more feature files), which may identify a specific page and/or an action (for example, identified by an action name) to perform if the user is on the specific page. For example, an exemplary feature file (for example, a Gherkin feature file) may state “Given the user is on page <PageName>,” perform an action identified by an action name. In some aspects, the feature files may replace the instruction sheets previously described, and therefore be used to generate test scripts that are in a more human readable (for example, codeless) format than the instruction sheets. A test script may be defined in the form of a feature file, and the test steps for these feature files may follow a set of pre-defined step formats.

The feature files may be formatted in either imperative style or declarative style. That is, aspects described herein may support both imperative and declarative styles, and in a codeless manner.

An exemplary imperative style is described as follows:

Scenario: Login into UITools (Imperative style)

Given the application is UITools

When I navigate to Login page

And I fill in “CompanyID” with “companyl”

And I fill in “UserID” with “userl”

And I fill in “Password” with “cash01pro”

And I press “Login”

Then I should get to Home page

An exemplary declarative style is described as follows:

Scenario: Login into UITools (Declarative style)

Given the application is UITools

When I try to login providing valid credentials

Then I should get to Home page

In the above example, the application may comprise “UITools,” the action name may comprise a “login” action, the data label may comprise “valid credentials,” and the page may comprise the “Home page.”

The code testing tool 230 may determine whether the current page that the user is on is the specified page (for example, a page identified as <PageName> as described above). If not, the code testing tool 230 may use a navigation catalog to find a way (for example, the shortest way) to get from the current page to the target or specified page. Code testing tool 230 may execute one or more navigation actions provided in the navigation catalog. The navigation catalogs may be used to support transparent navigation to the specified page.

The code testing tool 230 may comprise an actions catalog. The actions catalog may be used by the code testing tool 230 to convert humanly readable action names (for example, custom action names and/or DSL action names) into other formats of reusable actions that are recognizable by the framework 205, such as the reusable actions. Some simple actions might not need to use an action catalog to be converted to other formats. For example, actions such as selecting, clicking, and checking that may be converted from humanly readable formats to, for example, other formats, such as (respectively) filling, acting, and verifying (which may be the corresponding UI Maps actions). These and other simple steps may be performed directly in steps definitions without the help of an action catalog.

By using action catalogs, codeless DSLs may be supported according to one or more features described herein. Both navigation catalogs and action catalogs may be based upon the concept of reusable actions. Each reusable action may represent a group of more granular instructions coming with their own data and taking predefined parameters as input.

Data information for conversions may come from steps to step definitions in the form of direct data or as a data label. The data label might not be standard for some code testing tools. However, data labels may be used for various aspects described herein to allow externalizing data and keeping it separately from the feature files of the code testing tools. In other words, support for both direct data input methods and externalized data may be provided using aspects described herein. Supporting data externalization may, for example, allow using different data for different test environments.

To use data labels, page catalogs or data catalogs may be implemented. For a given page name, the page catalog may allow finding the corresponding UI Map and what data sources are associated with that page. That is, the page catalog may indicate where the system may look for the provided data label. It may also point to the navigation action that may be used to navigate to the specified page.

An extensive set of step definitions covering one or more code testing scenarios is provided herein. These step definitions may be short, and may incorporate calls to action catalogs and data catalogs, if needed. The step definitions may also redirect the flow to framework core 250. Though step definitions may be common for a plurality of applications (for example, common step definitions) to be tested (for example, all of the applications), some applications may use additional step definitions (for example, application specific step definitions) to support sentences that are specific to those applications. The implementation of these custom definitions may be lightweight, and in some instances may redirect to existing step definitions.

A parser may parse test steps to identify the text and their corresponding actions. In some aspects, the parser and/or another parser may parse a set of instructions (for example, a feature file) to determine an action to perform and to determine data to use for the action to perform.

One or more of the components illustrated in FIG. 2 may optionally comprise a particular type of component, such as a UI maps common component, an application specific component, or a 3^{rd} party component. However, the components illustrated in FIG. 2 are not limited to their illustrated configuration and may each comprise a different type of component.

An example of a login scenario using the code testing tool 230 will now be described.

| Step | Actions |
|---|---|
| Given that | 1) Search in the Data Catalog for the UIMap corresponding |
| Login | to the “Login” page name. |
| page is | 2) Verify with the data from UIMap if the page is visible. |
| displayed | 3) If it is visible, the Given condition is satisfied. |
| | 4) If the page is not visible, determine the corresponding |
| | Navigate Action using Page catalog, and execute the action |
| | in order to get to the page. |
| When user | 1) The word “perform” indicates that a Reusable Action is |
| tries to | to be executed. |
| perform | 2) Text following the “perform” keyword in square |
| [login] | brackets may comprise the name of the action. Actions |
| with | Catalog may be used to find the corresponding action. |
| [valid | 3) Presence of keyword “with” following the action name |
| credentials] | may indicate that the data to be used for this operation is |
| | provided. |
| | 4) Presence of text surrounded by square brackets may |
| | indicate that data is identified by a data label. |
| | 5) For Login page, using Page Catalog, determine |
| | corresponding data sheet with “valid credentials” label on |
| | it |
| | 6) Action and Data information is passed from the code |
| | testing tool 230 to the framework 250, and executed. |
| Then | 1) The keyword “confirm” indicates use of UIMap. Verify |
| confirm | operation |
| that | 2) That keyword is followed by data label within [ ]. |
| [login is | 3) Last page used was Login page, so, again, find “login is |
| successful] | successful” label on data sheets belonging to that page. |
| | 4) Action and Data information is passed from the code |
| | testing tool 230 to the framework 250, and executed. |
| | 5) In the process of execution of that action, confirm that |
| | another page was reached, as expected. Determine and |
| | store indicator of that new page as the current location in |
| | the application. |

The exemplary set of instructions above may be parsed to determine an action to perform. For example, a parser may determine, in the set of instructions, a location of a trigger (for example, the term “perform” or any other trigger term) indicating the action to perform. Based on the location of the trigger indicating the action to perform, it may be determined that text in the set of instructions following the trigger comprises a name of the action to perform. For example, the action to perform may comprise a login action.

The exemplary set of instructions above may be parsed to determine the data to use for the action to perform. For example, a parser may determine, in the set of instructions, a location of a trigger (for example, the term “with” or any other trigger term) indicating the data to use for the action to perform. Based on the location of the trigger indicating the data to use for the action to perform, it may be determined that text in the set of instructions following the trigger comprises a name or a location of a data sheet storing the data to use for the action to perform. For example, the data to use for the action may comprise credentials, such as valid credentials.

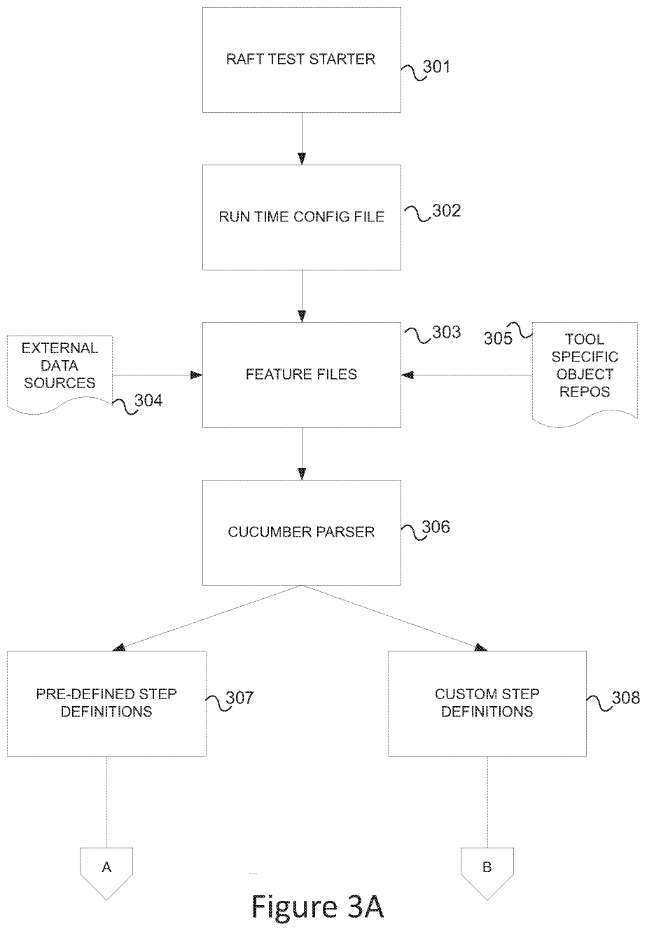

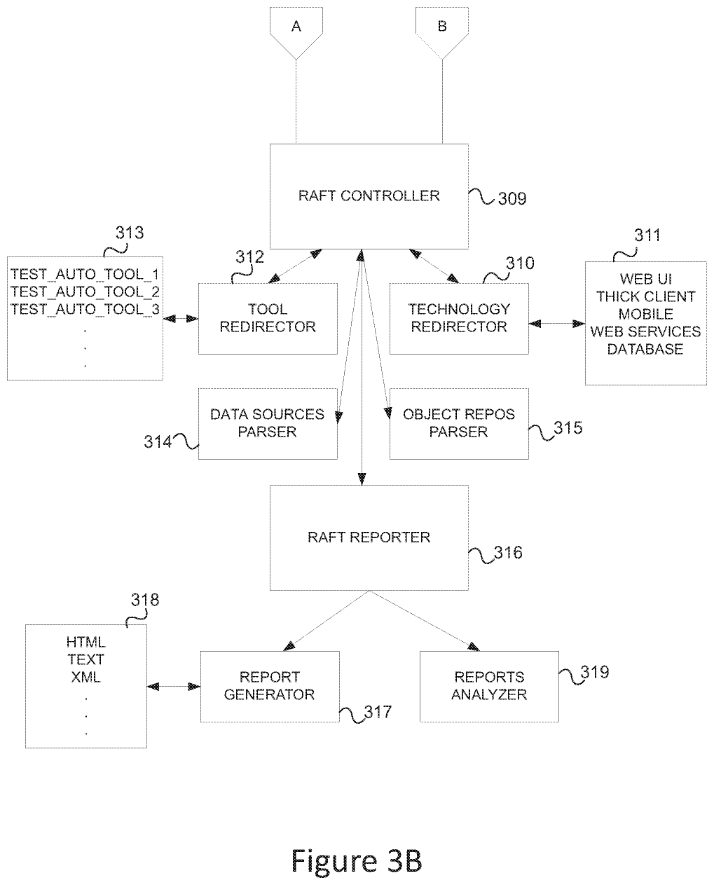

FIGS. 3A-B illustrates a component interactions flow for a Rapid Automation First-pass Testing framework (for example, framework 205) according to one or more illustrative embodiments.

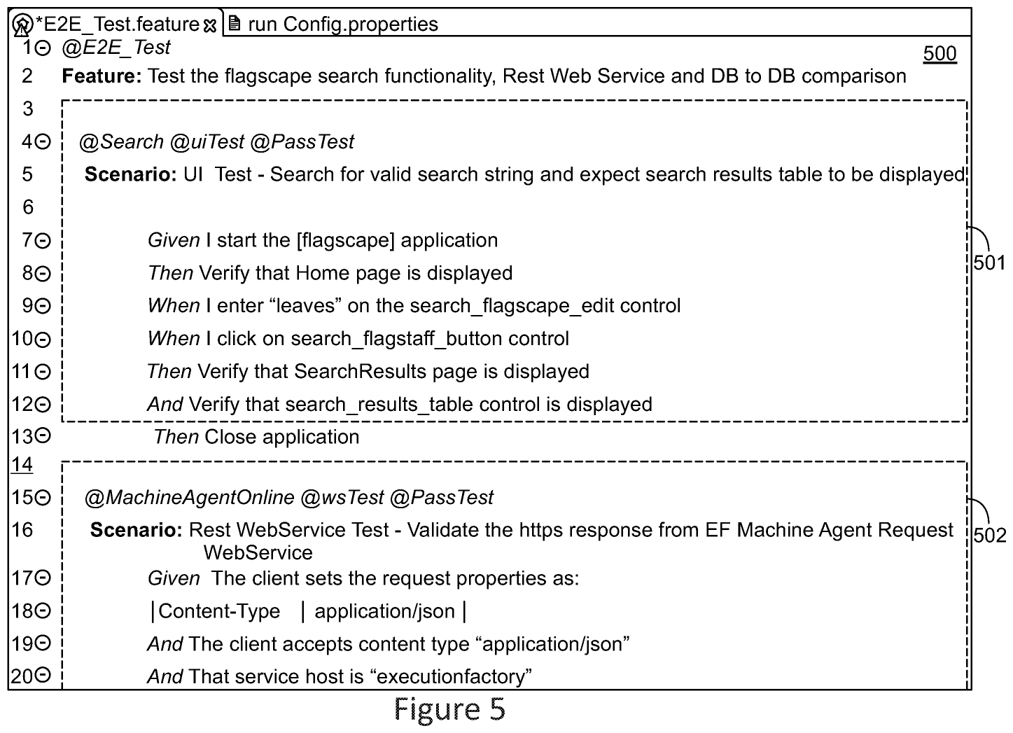

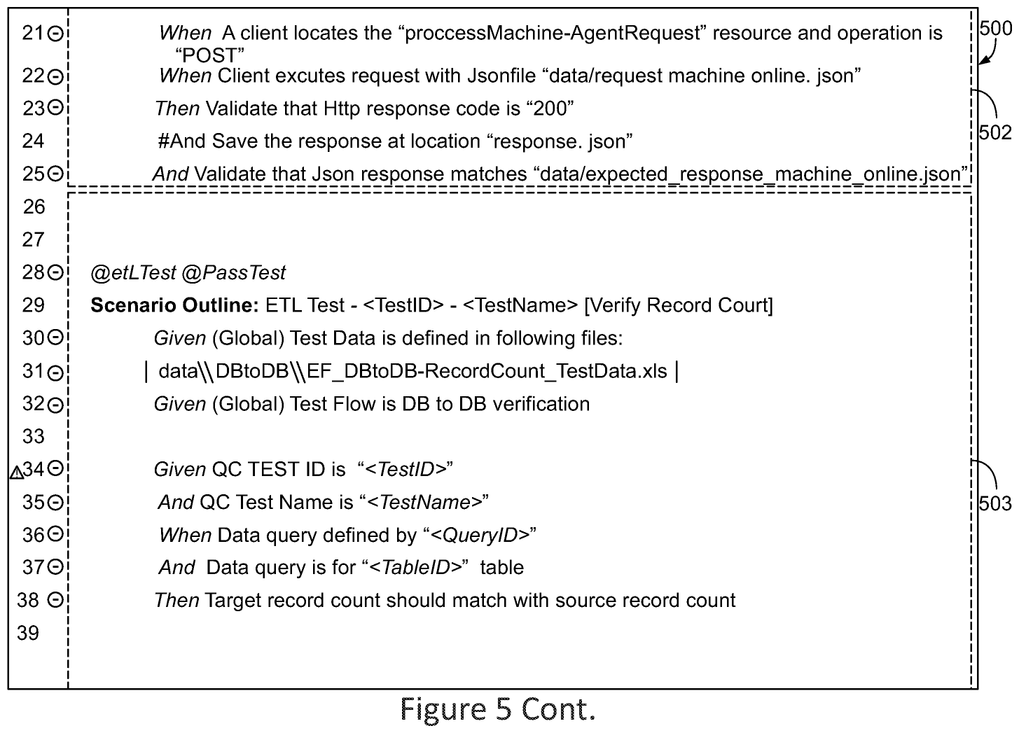

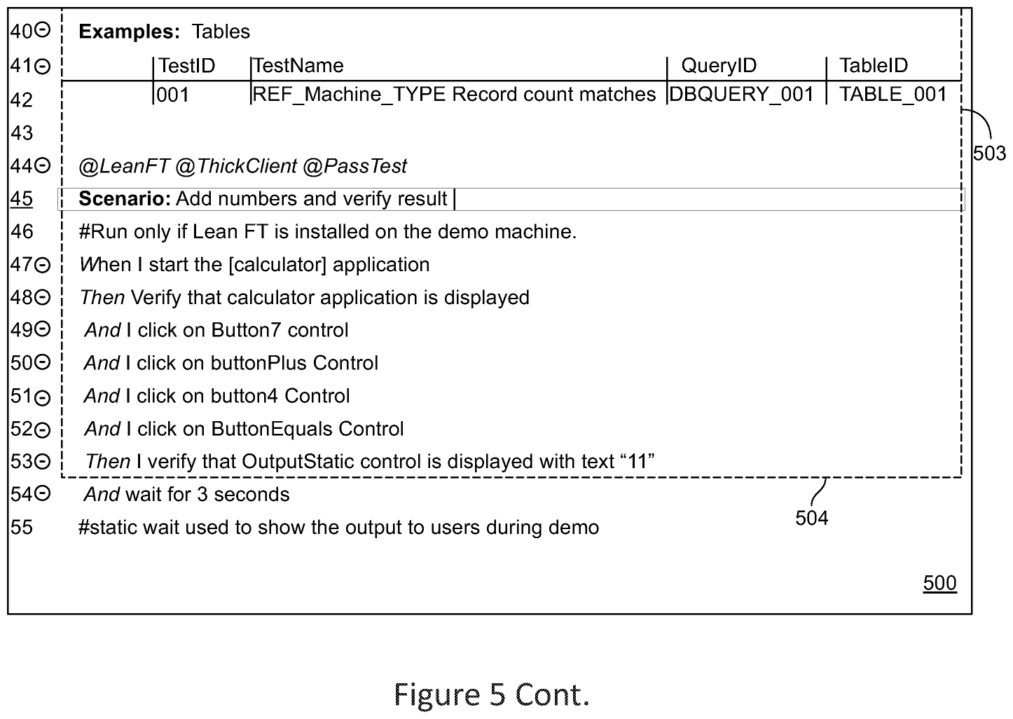

Referring to FIG. 3A, at block 301 feature testing is initiated, for example, by accessing feature file 500 (as shown in FIG. 5). The feature testing is executed in accordance with configuration information obtained from a run time configuration file accessed at block 302. Configuration information may include information about what scripts need to be executed and whether they should be executed locally or remotely and using what tools. Configuration information may also include information about where the applications under test can be accessed (for example, URL, path to executable, test environment, and so forth), credentials, external data source information, the folder/file where the test results should be stored, the type(s) of report(s) that should be generated (for example, HTML, XML, JSON), and so forth.

One or more feature files are accessed at block 303 in conjunction with accessing data from an external data source at block 304 or from data included in the feature file. Also, one or more objects may be accessed from a tool specific object repository at block 305. For UI tools that don't have object repositories, RAFT framework 205 may implement its own object repository. For tools that provide an object repository out of the box, RAFT framework 205 may modify/extend/enhance an existing object repository incorporating additional information required for RAFT operations (for example, UIMaps information).

At block 306, steps from the feature are parsed into pre-defined step definitions at block 307 and/or custom step definitions at block 308. Pre-defined step definitions are already implemented by RAFT framework to support codeless automation. Generically defined RAFT steps may address the majority of automation needs transparently for the users, regardless of tool that should be used. RAFT framework 205 performs the switch to the proper tool internally if needed. If RAFT pre-defined steps do not address the user's need fully, then users have the option to write custom step definition, while continuing to use majority of RAFT functionalities.

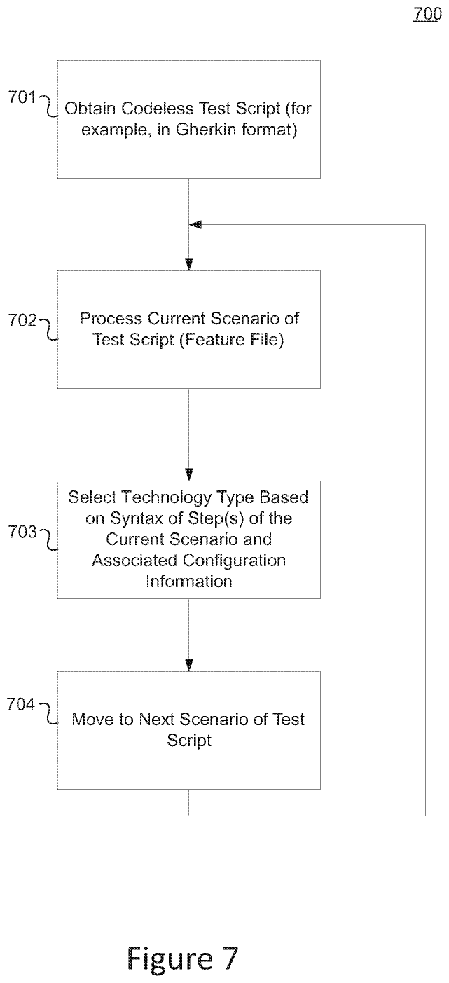

FIG. 3B is a continuation of FIG. 3A. RAFT controller 309 (which may be implemented with core framework 250 as shown in FIG. 2). RAFT controller 309 determines the technology type 311 via technology redirector 310 from the syntax of steps in the feature file as will be discussed with FIG. 7. Also, RAFT controller 309 determines the corresponding test automation tool 313 via tool redirector 312. Tool redirection in particular for UI is determined based on the information about the object repository type that describes current page. This information is stored in RAFT catalogs. However, for some technology types, the RAFT framework may directly interact with an application without a test automation tool using a coded format such as Java code.

A primary function of data source parser 314 is to allow RAFT framework 205 to consume data provided by a user in different formats as well as from various sources. For example, formats may include XML, XLS, JSON, CSV, and so forth sourced from database(s) or local file(s) or embedded in feature files. Object repository parser 315 allows to extract information about UI objects (for example, their locators, UIMap properties, and so forth) from repositories of different automation tools.

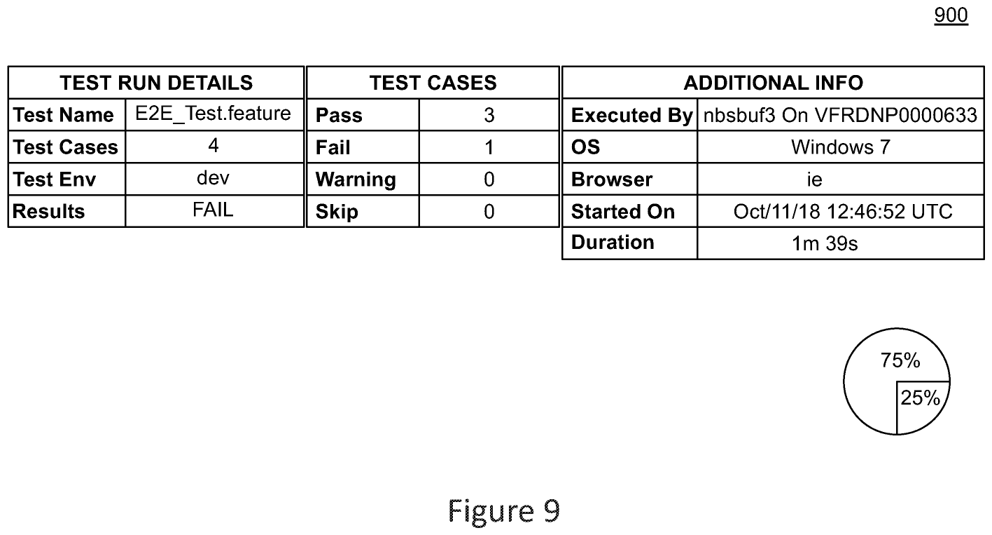

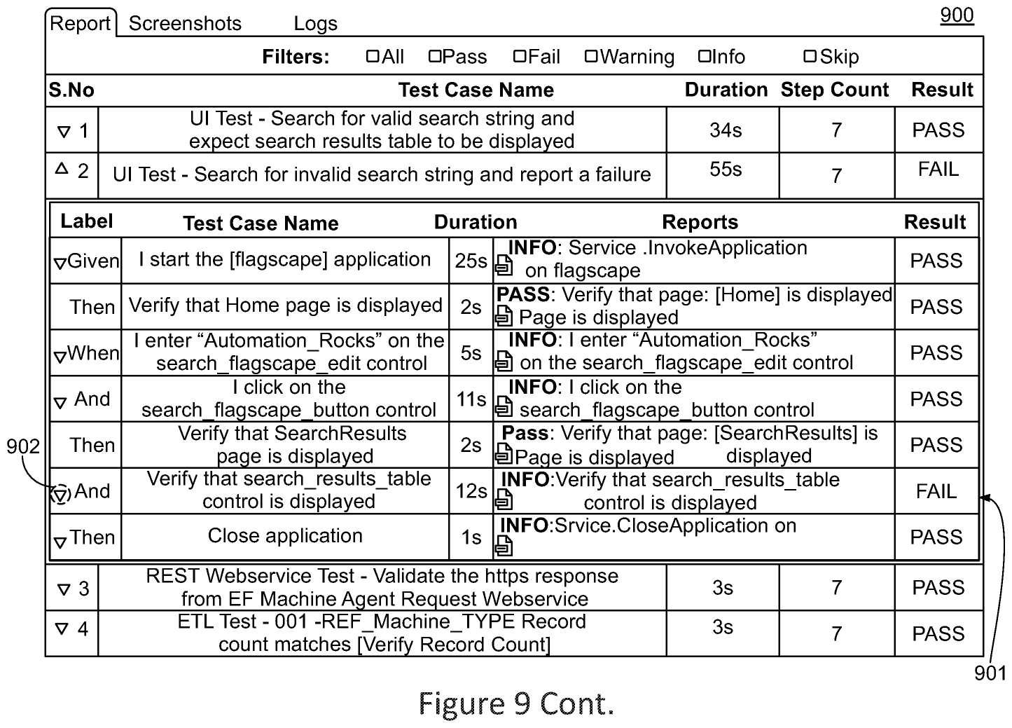

RAFT reporter 316 gathers test information as the test script (for example, feature file 500) is being executed by RAFT framework 205. Report generator 317 generates reports (for example, reports 900, 1000, and 1100 as shown in FIGS. 9-11, respectively) using one of report formats 318. In addition, test analysis information (for example test fail information), as determined by reports analyzer 319, may be included in the reports.

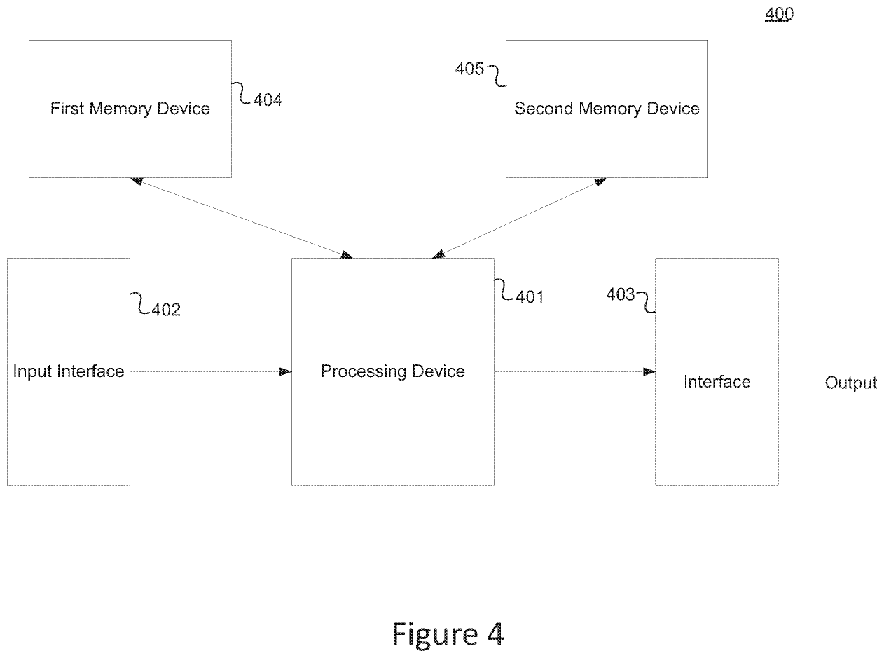

FIG. 4 illustrates an example of suitable computing system environment 400 for supporting framework 205, as shown in FIG. 2, according to one or more illustrative embodiments.

Computing device 401 may have a processor for controlling overall operation of the computing device 401 and its associated components, including memory devices 404 and 405, input interface 402, and output interface 403.

RAFT framework 205 receives testing artifact 210 via input interface 402 and instructs an application to execute actions 212 via output interface 403.

Computing device 401 typically includes a variety of computer readable media. Computer readable media may be any available media that may be accessed by computing device 301 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 401.

Although not shown, first memory device 404 may include one or more are applications representing the application data stored in first memory device 404 while computing device 401 is on and corresponding software applications (for example, software tasks), are running on the computing device 401.

Computer-executable instructions may be stored within first memory device 404 and/or storage to provide instructions to a processor for enabling computing device 401 to perform various functions. For example, memory device 404 may store computer-executable used by the computing device 401, such as an operating system, application programs, and an associated database. Alternatively, some or all of the computer executable instructions for computing device 401 may be embodied in hardware or firmware (not shown).

Embodiments of the invention may include forms of computer-readable media. Computer-readable media include any available media that can be accessed by a computing device 401. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

First memory device 404 may include one or more program modules having instructions that when executed by computing device 401 cause RAFT framework 205 to perform one or more functions described herein.

Although not required, various aspects described herein may be embodied as a method, a data processing system, or as a computer-readable medium storing computer-executable instructions. For example, a computer-readable medium storing instructions to cause a processor to perform steps (blocks) of a method in accordance with aspects of the invention is contemplated. For example, aspects of the method steps disclosed herein may be executed on a processor on computing device 401. Such a processor may execute computer-executable instructions stored on a computer-readable medium.

With some embodiments, automation library components 251-256 may be stored in second memory device 405 or in first memory device 404.

Computing device 401 may operate in a networked environment supporting connections to one or more remote computers, such as terminals. The terminals may be personal computers or servers that include any or all of the elements described above with respect to the computing device. The network connections include a local area network (LAN) and a wide area network (WAN), but may also include other networks. When used in a LAN networking environment, the computing device may be connected to the LAN through a network interface or adapter. When used in a WAN networking environment, the computing device may include a modem or other network interface for establishing communications over the WAN, such as the Internet. It will be appreciated that the network connections shown are illustrative and other means of establishing a communications link between the computers may be used. The existence of any of various well-known protocols such as TCP/IP, Ethernet, FTP, HTTP, HTTPS, and the like is presumed. Computing device and/or terminals may also be mobile terminals (for example, mobile phones, smartphones, PDAs, notebooks, tablets, and the like) including various other components, such as a battery, speaker, and antennas (not shown).

The disclosure is operational with numerous types of general purpose or special purpose computing devices. Examples of well-known computing devices that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Another illustrative system for implementing methods according to the present disclosure may be used. The system may include one or more workstations. The workstations may be used by, for example, agents or other employees of an institution (for example, a financial institution) and/or customers of the institution. Workstations may be local or remote, and are connected by one or more communications links to computer network that is linked via communications links to the server. In the system, the server may be any suitable server, processor, computer, or data processing device, or combination of the same.

A computer network may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. The communications links may be any communications links suitable for communicating between the workstations and the server, such as network links, dial-up links, wireless links, hard-wired links, and the like.

Computing device 401 may be used to create a test script for the code testing tool, which may comprise a plug-in or driver.

FIG. 5 illustrates feature file 500 in accordance with one or more example embodiments. File 500 may refer to text script (often written in a Gherkin format as shown in feature file 500) that includes one or more test scenarios 501-504 that one or more applications spanning one or more technology types. For example, scenarios 501-504 correspond to Web UI, Web services, database/ETL, and thick client technologies, respectively. In accordance with one aspect of the embodiments, feature file 500 may be executed in a seamless manner through a single (integrated) testing framework (for example, RAFT framework 205 as shown in FIG. 2).

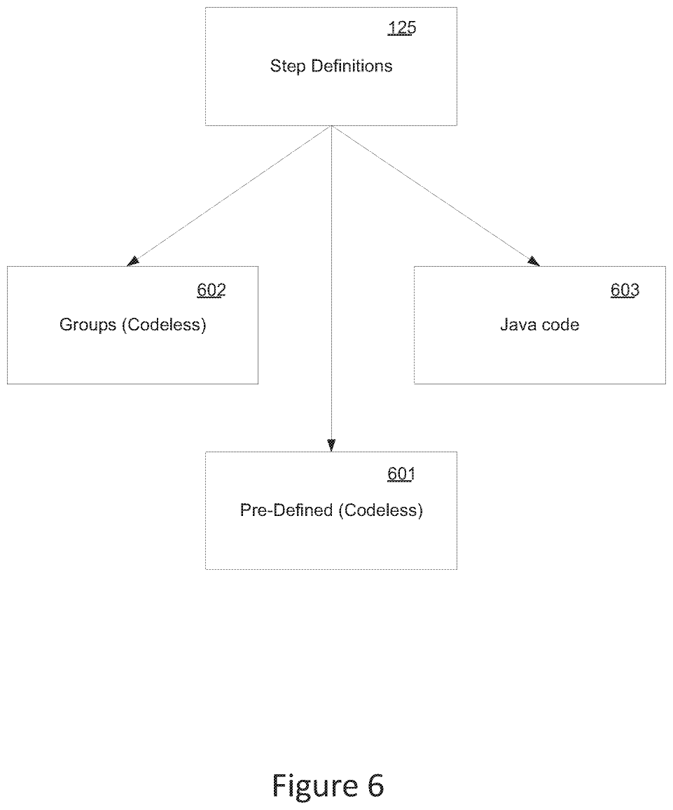

FIG. 6 illustrates various options that may be used with step definitions 125 when processing codeless testing script 210 (which may be referred as a first artifact) in accordance with one or more example embodiments. Step definitions 125 may be generated before processing codeless test script so that automated scripts can be generated without the need of a second artifact being constructed (for example, Java code).

With one aspect of the embodiments, The step definition 125 of step 120 may be characterized by one of three options: pre-defined steps 601, codeless groups 602, and Java code 603.

With pre-defined steps option 601, the steps can be used in a codeless way. So an action can be automatically performed on the application under test based on the pre-defined step. Generically defined RAFT steps can address majority of automation needs transparently for the users, regardless of tool that should be used. RAFT framework 205 performs the switch to the proper tool internally if needed.

Codeless groups option 602 enables a repetitive plurality of steps to be combined into one step. For example, according to traditional approaches, when one logins into an application, three steps are typically needed: 1) enter user name, 2) enter password, and 3) click login. With option 602, framework 205 combines the three steps into one, where the single step initiates the above three actions at the tested application.

With Java code option 603, one or more Java code instructions is automatically generated. Java code may be used in situations when testing of an application is directly performed rather than through a test automation tool.

FIG. 7 shows flowchart 700 that may be executed by a computing device (for example, RAFT framework 205 as shown in FIG. 2) for processing codeless test script 210 in accordance with one or more example embodiments.

At block 701, test script written in a Gherkin format is obtained. Framework 205 processes the test script by sequentially advancing through the codeless steps at block 702. Based on the syntax of the Gherkin format at the current step at block 703, the associated technology type is determined. For database technology (for example, corresponding to component library 255 as shown in FIG. 2), Gherkin syntax may refer to accessing a database while for Web UI technology (corresponding to component library 251), Gherkin syntax may refer to launching a webpage. At block 704, the computing device advances to the next step of the test script, and process 700 is repeated at block 701.

According to an aspect of the embodiments, the technology type can change while processing a test script. Because framework 205 integrates different technology types on a single platform, technology type changes can be supported. With traditional approaches, different frameworks are needed for different technology types, making it difficult to handle such situations.

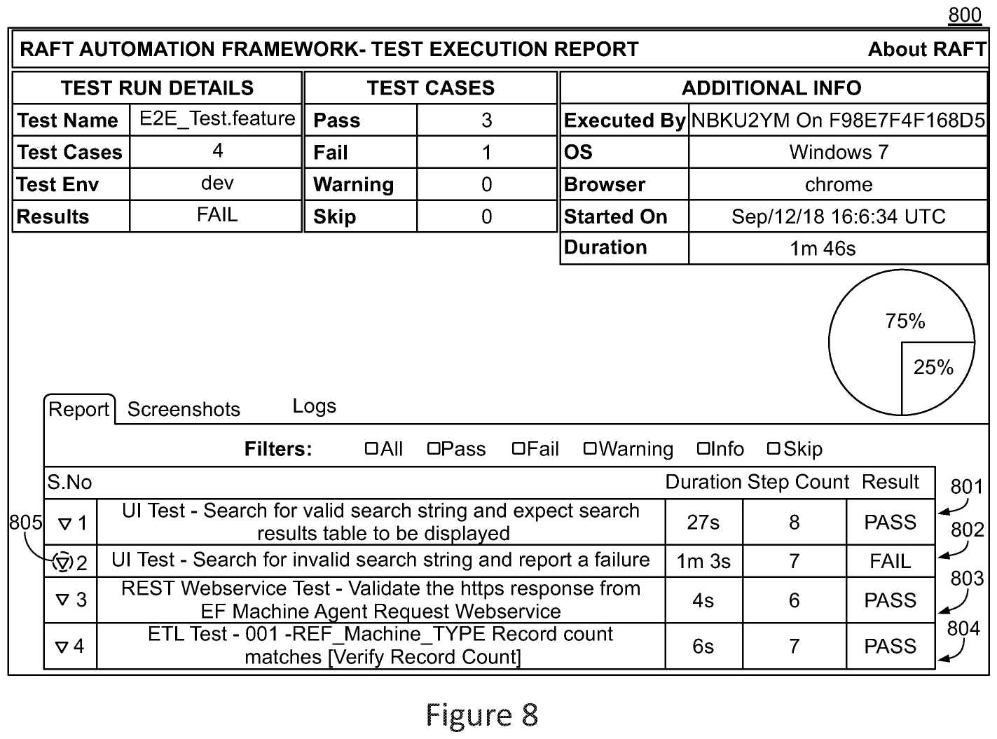

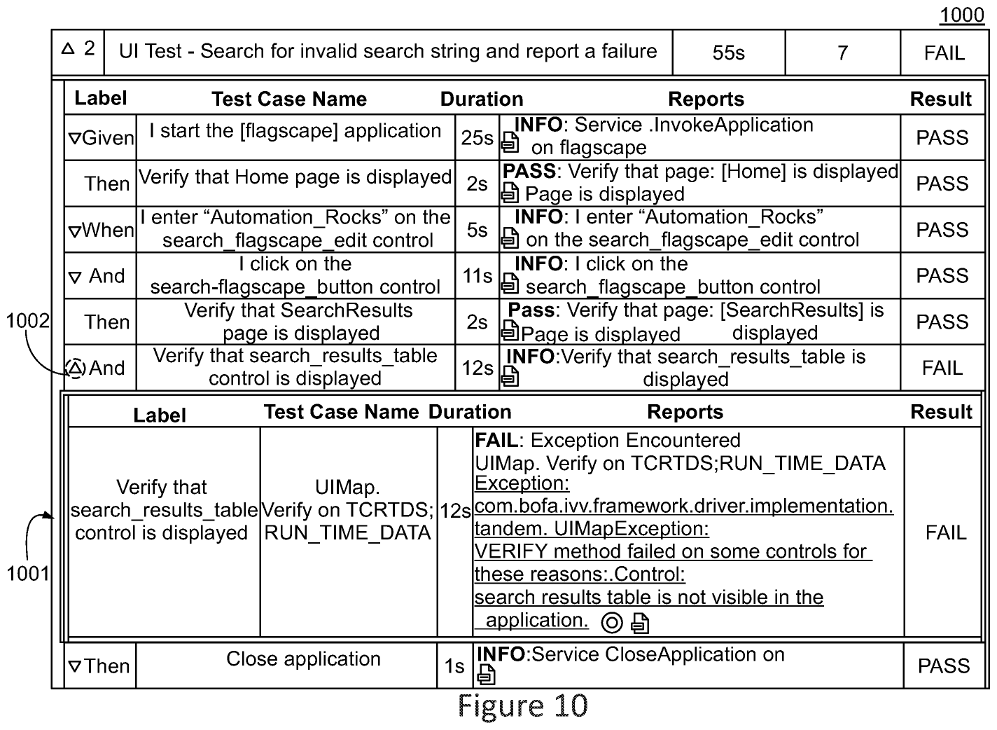

FIG. 8 illustrates an example of a test report 800 after executing codeless test script 210 through Rapid Automation First-pass Testing framework 205 in accordance with one or more example embodiments. Report 800 may be characterized by one of different formats (HTML as shown in FIG. 8) and may enable a user to drill down (as shown in FIGS. 9-10) into testing details varying from a high level to the specifics of log data as well as and view screen shots. The report may be contained in a single file, where information is embedded in the file, circumventing the need for having a plurality of files. With traditional approaches, the desired level of details about a test would be required before creating report files. With an aspect of the embodiments, a user may decide on the level of details after the creation of test report 800 by drilling down to the desired level.

Test report 800 shows results of different test cases 801-804. For example, test cases 801 and 803 may correspond to test scenarios similar to test scenarios 501 and 502 as shown in FIG. 5. Each test case includes one or more steps as will be discussed in FIGS. 9-10.

With one aspect of the embodiments, test cases 801-804 may be associated with different technology types. For example, test cases 802-804 are associated with Web UI, Web services, and databases/ETL, respectively.

If a user desires to obtain greater details for a particular test case, the user selects a corresponding drill-down indicator. For example, if the user selects drill-down indicator 805, test case 802 is expanded into corresponding steps (in the Gherkin format) in test report 900 as shown in FIG. 9. For example, step 901 indicates a fail result. The user may wish to determine details about the failure by selecting drill-down indicator 902. If so, the details of the fail result is displayed at entry 1001 as shown in FIG. 10. Since report 1000 is at the lowest level (corresponding to the greatest amount of detail), the user can revert back to the higher level by selecting drill-up indicator 1002.

Various aspects described herein may be embodied as a method, an apparatus, or as computer-executable instructions stored on one or more non-transitory and/or tangible computer-readable media. Accordingly, those aspects may take the form of an entirely hardware embodiment, an entirely software embodiment (which may or may not include firmware) stored on one or more non-transitory and/or tangible computer-readable media, or an embodiment combining software and hardware aspects. Any and/or all of the method steps described herein may be embodied in computer-executable instructions stored on a computer-readable medium, such as a non-transitory and/or tangible computer readable medium and/or a computer readable storage medium. Additionally or alternatively, any and/or all of the method steps described herein may be embodied in computer-readable instructions stored in the memory and/or other non-transitory and/or tangible storage medium of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (for example, air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

1. An application code testing computing device, comprising:
an input interface;
an output interface;
a processor; and
at least one memory device storing computer-executable instructions that, when executed by the processor, cause the application code testing computing device to:
receive, through the input interface, a set of instructions for testing at least one of a plurality of applications, wherein the set of instructions spans a plurality of test scenarios comprising a first test scenario and a second test scenario, wherein the plurality of applications include a first application associated with a first technology type and a second application associated with a second technology type, and wherein the set of instructions includes a first step and a second step;
process the first step of the set of instructions, wherein the first test scenario includes the first step;
based on syntax of the first step, identify that the first technology type is associated with the first step;
in response to the identifying the first technology type, instruct, via the output interface, the first application to perform a first action;
advance to the second step of the set of instructions, wherein the second test scenario includes the second step;
based on syntax of the second step, identify that the second technology type is associated with the second step, wherein the first and second technology types are different; and
in response to the identifying the second technology type, instruct, via the output interface, the second application to perform a second action.

2. (canceled)

3. The application code testing computing device of claim 1, wherein the at least one memory device stores computer-executable instructions that, when executed by the processor, cause the application code testing computing device to:
convert the first step having a first codeless format to a first converted step having a second codeless format; and
provide the first converted step to a first test automation tool for the first application to perform the first action.

4. The application code testing computing device of claim 3, wherein the at least one memory device stores computer-executable instructions that, when executed by the processor, cause the application code testing computing device to:
convert the second step having a first codeless format to a second converted step having a third codeless format; and
provide the second converted step to a second test automation tool for the second application to perform the second action.

5. The application code testing computing device of claim 3, wherein the first codeless format comprises an imperative scenario written in a Gherkin format or a declarative scenario written in the Gherkin format.

6. The application code testing computing device of claim 1, wherein the plurality of applications includes a third application associated with a third technology type and the at least one memory device stores computer-executable instructions that, when executed by the processor, cause the application code testing computing device to:
advance to a third step of the set of instructions, wherein a third test scenario includes the third step;
convert the third step having a first codeless format to a third converted step having a coded format; and
provide the third converted step to the third application to perform a third action.

7. The application code testing computing device of claim 1, wherein the at least one memory device stores computer-executable instructions that, when executed by the processor, cause the application code testing computing device to:
store a first library component and a second library component for the first and second technology types, respectively;
access the first library component when the first technology type is identified; and
access the second library component when the second technology is identified.

8. The application code testing computing device of claim 1, wherein a plurality of test automation tools supports the first technology type and wherein the at least one memory device stores computer-executable instructions that, when executed by the processor, cause the application code testing computing device to:
select a third test automation tool from the plurality of test automation tools, wherein the plurality of test automation tools include the third test automation tool.

9. The application code testing computing device of claim 1, wherein the at least one memory device stores computer-executable instructions that, when executed by the processor, cause the application code testing computing device to:
access data from an external source; and
determining the first action based on the first step of the set of instructions and the accessed data from the external source.

10. The application code testing computing device of claim 1, wherein the at least one memory device stores computer-executable instructions that, when executed by the processor, cause the application code testing computing device to:
generate a report for the testing, wherein:
the report includes a first test case is associated with a fourth technology type and a second test case is associated with a fifth technology type; and
the report includes embedded information in a single file; and
a user is able to drill down into details of the testing from the report.

11. The application code testing computing device of claim 10, wherein the at least one memory device stores computer-executable instructions that, when executed by the processor, cause the application code testing computing device to:
receive a drill-down indication to expand one of the test cases performed by the first application for the report;
access the embedded information in the single file; and
expand displayed information for said one of the test cases based on the indication.

12. The application code testing computing device of claim 3, wherein the at least one memory device stores computer-executable instructions that, when executed by the processor, cause the application code testing computing device to:
access an object from an object repository for the first test automation tool; and
process the first step based on the accessed object.

13. A method for integrated testing a plurality of applications spanning different technology types, the method comprising:
receiving a set of instructions for testing at least one of a plurality of applications, wherein the set of instructions spans a plurality of test scenarios comprising a first test scenario and a second test scenario, wherein the plurality of applications include a first application associated with a first technology type and a second application associated with a second technology type, and wherein the set of instructions includes a first step and a second step;
processing the first step of the set of instructions, wherein the first test scenario includes the first step;
identifying that the first technology type is associated with the first step based on syntax of first step;
in response to the identifying the first technology type, instructing the first application to perform a first action;
advancing to the second step of the set of instructions, wherein the second test scenario includes the second step based on syntax of the second step;
identifying that the second technology is associated with the second step, wherein the second technology type is different from the first technology type; and
in response to the identifying the second technology type, instructing the second application to perform a second action.

14. The method of claim 13, further comprising:
converting the first step having a first codeless format to a first converted step having a second codeless format; and
providing the first converted step to a first test automation tool for the first application to perform the first action, wherein the first test automation tool supports the first technology type.

15. The method of claim 14, further comprising:
converting the second step having a first codeless format to a second converted step having a third codeless format; and
providing the second converted step to a second test automation tool for the second application to perform the second action, wherein the first test automation tool is different from the second test automation tool.

16. The method of claim 14, wherein the first codeless format comprises an imperative scenario written in a Gherkin format or a declarative scenario written in the Gherkin format.

17. The method of claim 13, further comprising:
generating a report for the testing, wherein the report includes embedded information in a single filing and wherein a user is able to drill down into details of the testing and wherein the report spans a plurality of technology types;
receiving a drill-down indication to expand one of the steps performed by the first application for the report;
accessing the embedded information in the single file; and
expanding displayed information for said one step based on the indication.

18. The method of claim 13, further comprising:
advancing to a third step of the set of instructions, wherein a third test scenario includes the third step;
converting the third step having a first codeless format to a third converted step having a coded format; and
providing the third converted step to a third application to perform a third action.

19. One or more non-transitory computer-readable media storing computer-readable instructions that, when executed by an application code testing computing device, cause the application code testing computing device to:
receive a set of instructions for testing at least one of a plurality of applications, wherein the set of instructions spans a plurality of test scenarios comprising a first test scenario and a second test scenario, wherein the plurality of applications include a first application associated with a first technology type and a second application associated with a second technology type, and wherein the set of instructions includes a first step and a second step;
process the first step of the set of instructions, wherein the first test scenario includes the first step;
identify that the first technology type is associated with the first step based on syntax of first step;
in response to the identifying the first technology type, convert the first step having a first codeless format to a first converted step having a second codeless format;
provide the first converted step to a first test automation tool for the first application to perform a first action, wherein the first test automation tool supports the first technology type;
advance to the second step of the set of instructions, wherein the second test scenario includes the second step;
identify that the second technology type is associated with the second step based on syntax of the second step, wherein the second technology type is different from the first technology type;
convert the second step having a first codeless format to a second converted step having a third codeless format; and
provide the second converted step to a second test automation tool for the second application to perform a second action, wherein the second test automation tool supports the second technology type.

20. (canceled)
